(19) United States
(12) Patent Application Publication
(10) Pub. No.: US 2026/0042304 A1
(43) Pub. Date: Feb. 12, 2026

(54) METHOD FOR PROCESSING A PRINTED WEB AND INSTALLATION THEREFOR

(71) Applicant: BHS Corrugated Maschinen- und Anlagenbau GmbH, Weiherhammer (DE)

(72) Inventor: Karl Ruhland, Pfreimd (DE)

(21) Appl. No.: 19/100,255

(22) PCT Filed: Aug. 2, 2023
(86) PCT No.: PCT/EP2023/071464

§ 371 Date: Jan. 31, 2025

(30) Foreign Application Priority Data
Aug. 9, 2022 (DE) 10 2022 208 283.4

(51) Int. Cl. B41J 11/66; B41J 3/28; G06K 15/02

(52) U.S. Cl. CPC B41J 11/663; B41J 3/286; G06K 15/024; G06K 15/1843

(57) ABSTRACT

A method is indicated for processing a web (4) that is printed with a printed image (6), wherein the web (4) is fed to a cutting/grooving unit (14) by means of which the web (4) is processed at a number of processing positions (16) in the longitudinal direction (L), wherein upstream of the cutting/grooving unit (14) the web (4) has a width (B), wherein an actual measurement (1) for the width (B) is measured, wherein the cutting/grooving unit (14) is set depending on the actual measurement (1) and a target measurement (S) for the width (B) such that the processing positions (16) are adapted to the printed image (6). A corresponding installation (2) for such processing is also indicated.

The invention relates to a method for processing a web, which is printed with a printed image, i.e. a printed web. The invention also relates to a corresponding installation therefor.

One example of a web is a corrugated cardboard web. This is assembled from a plurality of layers of paper and, if applicable, is also printed. The corrugated cardboard web is produced using a corrugated cardboard production unit, at the end of which a cutting of the corrugated cardboard web into single panels is regularly carried out, which are then further divided into single sheets, e.g. folding boxes. For this purpose, the corrugated cardboard web is typically cut longitudinally and transversely and thus divided into single panels and sheets. If applicable, the corrugated cardboard web is also grooved longitudinally and/or transversely.

The sheets should often be printed, e.g. with a picture, a logo, a decoration or the like. A corresponding printed image can either be printed on the single sheets after longitudinal and transverse cutting, or already before that. In the latter case, the printed image is referred to as a “preprint.” With a preprint, the dimensional accuracy of the corrugated cardboard web is problematic, because a change in the dimensions of the corrugated cardboard web between printing and longitudinal and transverse cutting regularly results in the cuts produced during longitudinal and transverse cutting not aligning optimally with the print. The same problem exists with grooving.

EP 3 337 666 B1 describes a printing installation in which, on the one hand, graphics are printed on a single substrate web for a plurality of different arrangements of corrugated cardboard boxes to be lined with the web, and, on the other hand, machine-readable images represent corrugated cardboard production unit control information for producing the plurality of different arrangements of boxes. The corrugated cardboard production unit control information contains registration marks, which represent position information that is used for dynamically adapting the position of the corrugated cardboard and/or cutting and folding tools for each of the different arrangements.

EP 3 360 639 B1 describes a method for producing blanks from corrugated cardboard, comprising cutting a corrugated cardboard web comprising at least one variable cutting tool that is not bound in shape, wherein the cutting tool is used to introduce cutting lines into the material web, which produce the contour of a blank. A planning unit plans the position of the blanks in the corrugated cardboard web, wherein the expected shrinkage behavior of the corrugated cardboard web, which is not yet dimensionally stable, is taken into account by the cutting tool that is not bound in shape and can be calculated and adapted in advance by scaling the planned blank.

Against this background, it is an object of the invention to improve the processing of a printed web, in particular to improve the cutting and/or grooving of a printed web, in particular a corrugated cardboard web. It is sought to specify a suitable method and an installation for this purpose.

The object is achieved according to the invention by a method having the features of claim 1 and by an installation having the features according to claim 11. Advantageous embodiments, further developments, and variants are the subject of the dependent claims. The statements in connection with the method also apply analogously to the installation, and vice versa. Advantageous embodiments of the installation result from the fact that it is designed to carry out the method described below, specifically one or more of its steps. In particular, the installation has a control unit that is correspondingly designed for this purpose.

The method according to the invention is used for processing a web that is printed with a printed image. Printing is carried out in particular with a printing machine and is not itself necessarily part of the method described here. The printed image comprises in particular everything that is printed on the web (e.g., images, logos, decorations, lettering etc. for the single panels or sheets and/or control codes, alignment marks etc. for the installation). In a suitable embodiment, printing is part of the method described here, but this is not necessary. In a suitable embodiment, printing is carried out inline with the processing. In particular, the web is made of paper and is either single-ply, consisting of only a single layer of paper, or multi-ply, consisting of a plurality of layers of paper. Preferably, the web is a corrugated cardboard web and thus multi-ply. The processing is generally carried out by an installation, preferably a corrugated cardboard production unit, which is assumed below without limitation of generality. The processing is carried out after the printed image has been printed, i.e. the processing described below involves a preprint, in particular the printed image is printed on a single layer of paper before this is joined to other layers of paper in the corrugated cardboard production unit to form the corrugated cardboard web.

The web is fed to a cutting/grooving unit of the installation and, by means of the cutting/grooving unit, the web is processed at a number of processing positions (i.e., cutting and/or grooving positions) in the longitudinal direction. A cutting/grooving unit is understood to mean in particular a cutting and/or grooving unit, i.e. a unit that is designed either for cutting the web or for grooving the web, or both. Accordingly, the cutting/grooving unit introduces one or more cuts and/or grooves in the web, specifically longitudinal cuts and/or longitudinal grooves, since the processing is carried out in the longitudinal direction. In the following, without limiting the generality, a cutting and grooving unit is assumed, with which the web is both cut and grooved. The longitudinal direction corresponds to a conveying direction of the web through the installation. The processing positions are accordingly those positions along the web at which one or more cuts and/or grooves are introduced by the cutting/grooving unit. The cuts and/or grooves are used in particular for cutting the corrugated cardboard web into single panels and/or for forming break, fold or crease edges of the panels or the later sheets, e.g. to form each of these into a box, carton or the like. The introduction of cuts and/or grooves and thus the processing by the cutting/grooving unit is also referred to as “cutting to size”, the corresponding processing positions are also referred to as “cuts”.

In a suitable embodiment, the cutting/grooving unit is provided downstream of a so-called “double facer” of the installation. In the double facer, a plurality of intermediate products for a corrugated cardboard web are assembled to form the actual corrugated cardboard web. In particular, the double facer also marks the end of a so-called “wet end” of the installation (and is still part of it), which is followed by a so-called “dry end”, with which a cutting of the corrugated cardboard web is carried out, in particular into single panels and subsequently into single sheets. In particular, the cutting/grooving unit is part of the dry end of the installation. Suitably, the web is even cut into a plurality of separate partial webs (i.e., panels) with the cutting/grooving unit (in the longitudinal direction). Therefore, the cutting/grooving unit is also referred to as a longitudinal cutter. The partial webs do not necessarily have to be identical, but can also differ from one another, in particular with regard to the printed image as well. Downstream of the cutting/grooving unit, the installation is suitably equipped with a cross cutter, which cuts the partial webs in the transverse direction (i.e., perpendicular to the longitudinal direction) and thus divides them in particular into single sheets. An optional divider is provided between the cutting/grooving unit and the cross cutter. A short cross cutter is also optionally provided between the double facer and the cutting/grooving unit, which cuts the web in the transverse direction like the cross cutter, but with the aim of sorting out rejects or unneeded intermediate pieces of the web.

Upstream of the cutting/grooving unit, the web has an actual width, also referred to simply as the width for short. The actual width is the true width of the web and is measured in the transverse direction. Within the scope of the method, an actual measurement for the width is measured and the cutting/grooving unit is set depending on the actual measurement and a target measurement for the width such that the processing positions are adapted to the printed image. Here, in a suitable embodiment, the actual measurement for the width is measured and a scaling factor is ascertained from this together with a target measurement, in order to adapt the processing positions to the width. In principle, it is advantageous to measure the width directly, so that the actual measurement is identical to the actual width. However, other measurements are also suitable as actual measurements, in particular a distance between two printed features of the printed image or generally a distance between any features of the web. The distance is measured in the transverse direction and thus corresponds to part of the width. It is important to note that as soon as the width varies, the actual measurement also varies as a matter of principle. This means that a variation in the actual width can be recognized by measuring the actual measurement.

In the present case, the cutting/grooving unit is set depending on the actual measurement and the target measurement such that the processing positions are adapted to the printed image. In a suitable embodiment, more precisely, the cutting/grooving unit is set depending on the above-mentioned scaling factor such that the processing positions are adapted to the printed image. Accordingly, the cutting/grooving unit can be set and is advantageously set automatically depending on the actual width (by means of the actual measurement), so that the cuts and/or grooves always match the printed image exactly. In particular, the processing positions, i.e. the layout of the cuts and/or grooves, are scaled with the scaling factor for this purpose. Accordingly, a variation of the actual width and thus an actually undesired scaling of the printed image is compensated for by a corresponding scaling of the cutting/grooving unit. Accordingly, a core idea of the invention is in particular that the processing positions of the cutting/grooving unit are adapted to the actual printed image, so that the resulting cuts and/or grooves align better with the actual printed image. In other words, the cut is scaled and thus adapted to the actual dimensions of the printed image. Any resulting deviation of the actual dimensions of the panels/sheets from the specified target measurement, in particular from order data, is accepted. This is in contrast to the reverse approach of adapting the printed image to fixed processing positions, i.e. positioning the cuts and/or grooves exactly as specified in the order data (such a control by scaling the printed image is also advantageous, however, as described below). In this case, the target measurement is retained, but with the disadvantage of a printed image that is not optimally positioned if the dimensions of the web change. Specifically, cuts according to external cutting measurements regularly no longer match the printed image. For example, the web is divided into five similar partial webs with the cutting/grooving unit, i.e. the printed image has five similar images next to one another in the transverse direction, which are to be separated from one another accordingly and a certain width is specified as the target measurement in the order data. On its way to the cutting/grooving unit, the web undergoes an unexpected dimensional change, e.g. the web shrinks less than expected and now has an actual width that is greater than a target width that is identical to the target measurement or results from the target measurement (and, if applicable, an anticipated dimensional change, which, however, is not actually carried out). When dividing, this results in parts of the image of one partial web lying on the neighboring partial web. For example, when considering a single sheet that has been formed into a finished folding box, the printed image appears shifted relative to the edges and borders of the folding box, i.e. the print edge and the cut edge do not match. Since the web is typically guided into the cutting/grooving unit in a central position, the corresponding error increases outward in the transverse direction.

Accordingly, in contrast to the aforementioned EP 3 337 666 B1, in the present case, a genuine scaling of the processing positions and the cuts and/or grooves introduced thereby is carried out, i.e. the actual dimensions of the panels change. In contrast, in EP 3 337 666 B1, a positioning of the tools is only carried out relative to the printed image or to corresponding marks in order to compensate for a deviation in this respect, but a scaling of the tool itself is not undertaken. This only compensates for translation (slippage), but not scaling (shrinkage) of the web and the printed image.

In the likewise aforementioned EP 3 360 639 B1, the web can be printed either before or after cutting. The cutting tools are then set according to the expected shrinkage, so that the final corrugated cardboard sheet has the desired dimensions after all shrinking processes have been completed. Thus, the cut is adapted to the anticipated shrinkage processes. In contrast, in the present case, the cut is adapted to the actual shrinking processes such that the final end measurement (target measurement) may not be correctly maintained, but that the cut is adapted to the printed image, so that the distance from image edge to cut edge is aligned.

In addition to adapting the processing positions to the printed image, it is also advantageous in the present case to take into account the anticipated shrinkage processes, generally dimensional changes to the web. Accordingly, with the method, a dimensional change in the web is estimated (anticipated) in advance during its processing and it is taken into account that the printed image is printed on with the printing machine, in a scaled, in particular enlarged, manner, so that a variation in the estimated dimensional change is compensated for by the adaption of the processing positions to the printed image. In this case, printing in particular is part of the method described here. The estimated dimensional change is above all an expected dimensional change, which does not necessarily happen completely in the further course of the web through the installation. Accordingly, there are regular variations compared to the estimated dimensional change. The method described here thus advantageously contains two compensation mechanisms for any dimensional changes in the web, namely, on the one hand, for an estimated dimensional change and, on the other hand, for an actual dimensional change, specifically a variation (or deviation) from the estimated dimensional change. Firstly, the printed image itself is scaled from the outset depending on the anticipated dimensional change, e.g. target measurements of the printed image are multiplied by a corresponding scaling factor. The anticipated dimensional change is based in particular on empirical values that depend in particular on the specific order and the paper used. However, the anticipated dimensional change regularly does not take into account any variations during operation, i.e. no dynamic dimensional change, which results, e.g., from a varying web speed or from deviations during drying or moistening of the web. Such a dimensional change is now specifically taken into account by the method described here, because the measurement of the actual measurement detects precisely such a dimensional change and then compensates for it dynamically and preferably in real time and in particular automatically by scaling the processing positions. As a whole, this implements a two-stage correction, in which a first, rough, static correction is carried out in a first stage by adapting the printed image to the anticipated dimensional change, in particular in advance, and then a second, fine, dynamic correction is carried out in a second stage by adapting the processing positions to the printed image. The adaptation to the printed image is carried out indirectly by measuring the actual measurement. In the first stage, with the scaling of the printed image, an offset is in particular set, around which the scaling of the cutting/grooving unit is then dynamically controlled in the second stage.

Alternatively or additionally, with a further compensation mechanism, the scaling of the printed image to the target measurement is controlled depending on the actual measurement, so that the printed image is adapted to the target measurement (control by scaling the printed image). Such a control is carried out in particular before the web is fed to the cutting/grooving unit. This is particularly advantageous in an inline operation, in which a printing machine and a corrugated cardboard production unit are operated inline together. In particular, the printing machine is provided upstream of the corrugated cardboard production unit or integrated into the corrugated cardboard production unit upstream of the cutting/grooving unit. Here as well, printing in particular is part of the method described here. The disadvantage of this is that the printed image downstream of the printing machine cannot be further influenced and corrected by scaling the printed image until the measurement of the actual width. However, further corrections can be carried out advantageously by setting the cutting/grooving unit as described above.

A dimensional change of the web results during operation, in particular due to one or more moistening and/or drying processes of the web within the installation. The addition and removal of moisture causes the web to expand or shrink. In the dry end, a regular shrinkage relative to the wet end results, which shrinkage is particularly dependent on the web speed and thus the time it takes for the web to reach the cutting/grooving unit and during which the web releases moisture into the environment.

The scaling factor is formed from the actual measurement and the target measurement, e.g. simply as the ratio of the actual measurement to the target measurement or in another suitable manner. Depending on how the actual measurement and the target measurement are defined, a conversion may be necessary beforehand. For example, if the actual measurement is the width of the entire web and the target measurement is the width of a partial web, then the actual measurement must first be divided by the number of partial webs or, conversely, the target measurement must be multiplied by the number of partial webs. In another example, if the actual measurement is the distance between two printed features, then the actual measurement is converted to the width of the web based on the knowledge (from the order data) of the position of the printed features and then the procedure continues as in the example above. The target measurement is taken in particular from the order data for processing the web and is typically specified by the customer. The target measurement is a measurement of the dimensions that the single panels/sheets should have at the end, e.g. simply the sum of the widths of the partial webs if the actual measurement is simply the width of the entire web. In particular, the target measurement also specifies the processing positions, which are now scaled in the method described here in order to be adapted to the actual printed image.

For an adaptation of the processing positions that is as optimal as possible, the actual measurement is measured as close as possible to the cutting/grooving unit. In a suitable embodiment, the actual measurement is measured at most 50 m, at most 40 m, at most 30 m, at most 20 m or at most 10 m, preferably at most 1 m, upstream of the cutting/grooving unit. In this manner, any dimensional changes are covered as fully as possible, so that the adaptation to the actual printed image is particularly precise.

As already indicated, various embodiments are possible and suitable for the actual measurement; what is essential is that this allows conclusions to be drawn about the actual width and thus about the dimensions of the actual printed image.

In a first suitable embodiment, the actual measurement is simply the actual width, as already described above. The actual measurement is measured, for example, with a web width or web edge recognition system, for which the installation has a corresponding sensor unit. An embodiment in which the web has at least two layers of different widths is particularly advantageous, so that the actual width of the web and thus the dimensional change is determined by measuring the particular width of the two layers and comparing them with one another.

In a second suitable embodiment, the actual measurement is a distance between two printed features of the printed image. Accordingly, in this embodiment, the printed image is analyzed directly in order to recognize any dimensional changes in the web and the printed image. Which printed features are actually used is initially irrelevant. However, it is advantageous if they are as far apart as possible along the width of the web, i.e. the distance between the two printed features in the transverse direction is as large as possible. In this manner, it is ensured that the measurement of the actual measurement has sufficient resolution in order to recognize the typically small dimensional changes. The anticipated dimensional change is regularly approximately 0.7%, its variation during operation is then smaller and is regularly at most 0.3% (in both directions, i.e. +/−0.3%), in particular approximately 0.2%. With a web width of, e.g., 2800 mm, this is only approximately 5 to 6 mm, i.e. starting from the center of the web, a maximum of 3 mm on each side. Accordingly, a distance corresponding to at least 50% of the width of the web is expediently formed between the two printed features. This means that the two printed features are regularly located on different partial webs, preferably on the two outermost partial webs, i.e. once on an operating side of the installation and once on a drive side of the installation. Excessively small distances are unsuitable, depending on the measurement resolution.

In principle, all features that are present in the printed image are suitable as printed features. Suitable printed features are longitudinal lines (e.g., for web edge measurement), logos, images or picture elements (e.g., edges, borders), codes (e.g., QR or bar codes) either as part of the printing on the panels/sheets and/or for controlling the installation (so-called “control codes”). The use of printed features that are already present and do not need to be printed on in addition is particularly suitable. Control codes for the subsequent cross cutter, for example, are particularly suitable as printed features. These control codes are used in particular to activate the cross cutter and thereby generate a cross-section at a certain position relative to the control code.

In an advantageous embodiment, the actual measurement is determined by means of two sensors, which at the same time also set the cutting/grooving unit as a whole relative to the web course in the cutting/grooving unit. In particular, the web course refers to the position of the web relative to the transverse direction. The two sensors are part of a sensor unit, which in turn is part of the installation. The web does not necessarily enter the cutting/grooving unit at a certain point, but can be shifted in a transverse direction, depending on how the web is fed into the installation. Particularly if the installation is processing a web whose width is less than the maximum width that the installation can process, the web course can be centered or closer to the operating side or closer to the drive side of the installation. Accordingly, a tracking of the cutting/grooving unit is required in order to adapt the processing positions to the general web course as a whole and initially independently of a dimensional change. For this purpose, the installation has the specified two sensors mentioned, with which the web course is measured in order to correctly position the cutting/grooving unit in the transverse direction. With these two sensors, the actual measurement is now also measured in addition. Accordingly, if applicable the sensors are suitably designed, e.g. for recognizing the specified printed features.

The precise embodiment of the sensor unit and its sensors and the manner in which the printed features (or the width of the web) are recognized is of secondary importance for the method described here, what is important is that the actual measurement can be measured, however this is defined. As an alternative to the sensors described for the web course, a sensor unit that is also suitable in principle is regularly used immediately after a printing unit with which the printed image is printed on the web in order to inspect the same printed image. A corresponding sensor unit is also suitable for recognizing the printed features, but is then positioned as close as possible to the cutting/grooving unit.

For producing cuts and/or grooves at the processing positions, the cutting/grooving unit has a plurality of processing bodies. These processing bodies are provided in particular along the transverse direction. The processing bodies are designed in particular for mechanical processing of the web, in order to introduce cuts and/or grooves in it by mechanical action. A particular processing body has, e.g., a pair of rollers comprising two rollers and in each case one cutting blade or a groove contour. Preferably, the processing bodies are adjustable relative to one another and the cutting/grooving unit is set by adjusting the processing bodies relative to one another. In other words, the processing positions are scaled and adapted to the printed image by adjusting the processing bodies relative to one another, e.g. by increasing or decreasing their distance in the transverse direction.

In a preferred embodiment, the processing bodies are designed for parallel positioning and can be adjusted separately from one another for this purpose. In particular, the cutting/grooving unit has a separate adjustment mechanism for each of the processing bodies (e.g., in each case comprising a spindle) and the adjustment mechanisms can be controlled independently of one another. This is in contrast to serial positioning, which is typically unsuitable for the method described here, since only a single adjustment mechanism is used for a plurality of processing bodies.

The installation according to the invention is used for processing a web that is printed with a printed image. The installation has a cutting/grooving unit to which the web is fed in order to process it at a number of processing positions in the longitudinal direction. The web has an actual width upstream of the cutting/grooving unit. The installation also has a sensor unit, which is designed for measuring an actual measurement for the actual width, and also a control unit, which is designed to ascertain a scaling factor from the actual measurement together with a target measurement, in order to adapt the processing positions to the actual width. The control unit is then further designed to set the cutting/grooving unit depending on the scaling factor such that the processing positions are adapted to the printed image. The explanations above apply analogously to the installation.

In the following, exemplary embodiments of the invention are explained in more detail with reference to a drawing. In the drawing:

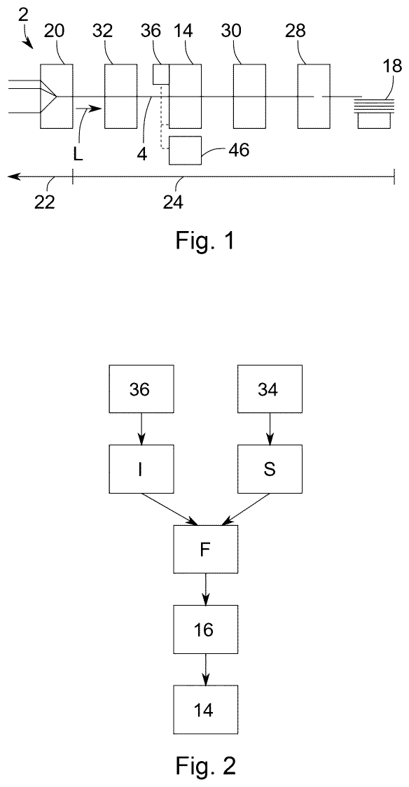

FIG. 1 an installation,

FIG. 2 a flow chart for a method,

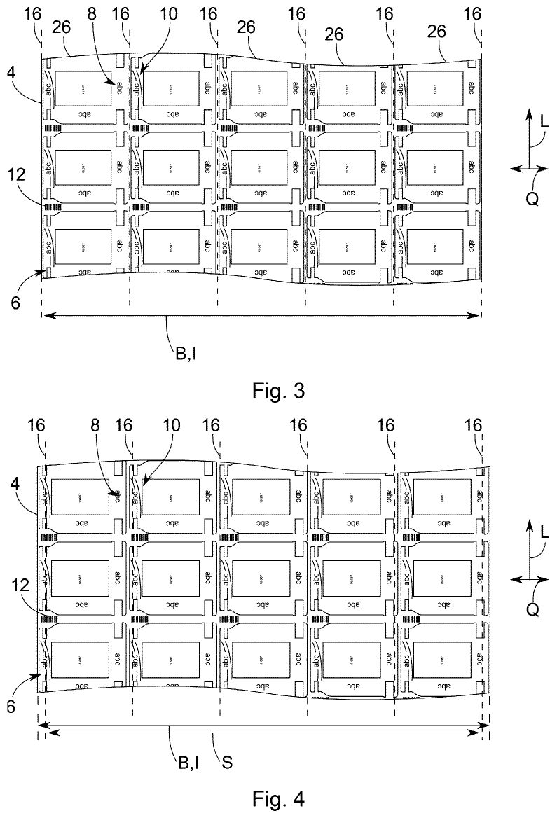

FIG. 3 a web comprising a printed image,

FIG. 4 the web from FIG. 3 after a dimensional change,

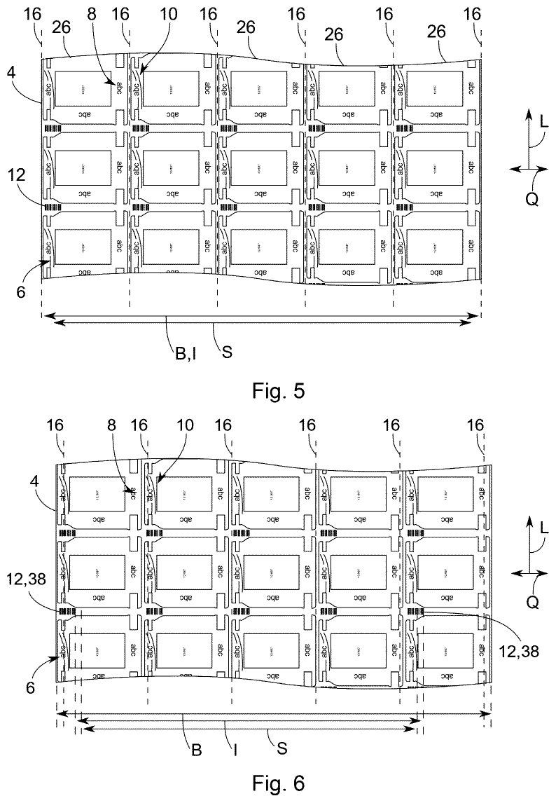

FIG. 5 the web from FIG. 4, after an adaptation of processing positions to the printed image,

FIG. 6 a distance between two printed features as an actual measurement,

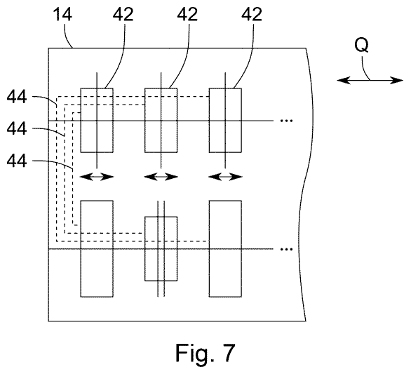

FIG. 7 a cutting/grooving unit of the installation from FIG. 1.

FIG. 1 shows an exemplary embodiment of an installation 2 for processing a web 4. The web 4 is printed with a printed image 6, which comprises everything that is printed on the web 4 (e.g., images, logos 8, decorations 10, lettering, control codes 12, alignment marks, etc.). Printing is not necessarily part of the method described here for processing the web 4. In the exemplary embodiment shown, the web 4 is made of paper and is a corrugated cardboard web and thus multi-ply. Here, the installation 2 is by way of example a corrugated cardboard production unit, but the following explanations also apply analogously to other installations 2 and webs 4. In any case, the processing of the web 4 described here is carried out after the printed image 6 has been printed, i.e. a preprint is present during processing.

The web 4 is fed to a cutting/grooving unit 14 of the installation 2 and, by means of the cutting/grooving unit 14, the web 4 is processed at a number of processing positions 16 (i.e., cutting and/or grooving positions) in the longitudinal direction L. The cutting/grooving unit 14 introduces one or more cuts and/or grooves in the web 4. In the following, without limiting the generality, a cutting and grooving unit 14 is assumed, with which the web 4 is both cut and grooved. The longitudinal direction L corresponds to a conveying direction of the web 4 through the installation 2. The processing positions 16 are accordingly those positions along the web 4 at which one or more cuts and/or grooves are introduced by the cutting/grooving unit 14, which are used for cutting the corrugated cardboard web into single panels 26 and for forming break, fold or crease edges of the panels 26 and later sheets 18.

In the embodiment shown here, the cutting/grooving unit 14 is provided downstream of a so-called “double facer” 20, in which a plurality of intermediate products for the corrugated cardboard web are assembled to form the actual corrugated cardboard web. The double facer 20 also marks the end of a so-called “wet end” 22 of the installation 2, which is followed by a so-called “dry end” 24, with which a cutting of the web 4 into the single panels 26 and finally sheets 18 is carried out. The cutting/grooving unit 14 is part of the dry end 24. In the present case, the web 4 is cut into a plurality of separate partial webs (i.e., the panels 26) by the cutting/grooving unit 14. Downstream of the cutting/grooving unit 14, the installation 2 here also has a cross cutter 28, which cuts the partial webs in the transverse direction Q and thus divides them into single sheets 18. Optionally, a divider 30 is also provided between the cutting/grooving unit 14 and the cross cutter 28. A short cross cutter 32 is also optionally provided between the double facer 20 and the cutting/grooving unit 14.

Upstream of the cutting/grooving unit 14, the web 4 has an actual width B, also referred to simply as the width for short. The actual width B is the true width of the web 4 and is measured in the transverse direction Q. Within the scope of the method, an actual measurement I is measured for the actual width B and a scaling factor F is ascertained from this together with a target measurement S, in order to adapt the processing positions 16 to the actual width I. The cutting/grooving unit 14 is then set depending on the scaling factor F such that the processing positions 16 are adapted to the printed image 6. This is shown by way of example in the flow chart in FIG. 2. Accordingly, the cutting/grooving unit 14 can be set and is automatically set depending on the actual width B (by means of the actual measurement I), so that the cuts and/or grooves always match the printed image 6 exactly. For this purpose, the processing positions 16, i.e. the layout of the cuts and/or grooves, are scaled with the scaling factor F. A variation of the actual width and thus an actually undesired scaling of the printed image 6 is accordingly compensated for by a corresponding scaling of the cutting/grooving unit 14.

Overall, the processing positions 16 of the cutting/grooving unit 14 are adapted to the actual printed image 6, wherein a resulting deviation of the actual dimensions of the panels 26 from the specified target measurement S from order data 34 is accepted. This is in contrast to the reverse approach of adapting the printed image 6 to fixed processing positions 16, i.e. a positioning of the cuts and/or grooves exactly as specified in the order data 34. In this case, cuts and/or grooves would regularly no longer match the printed image 6. This is illustrated by way of example in FIG. 3-5, which in each case show the web 4 and the processing positions 16 in a top view of the web 4. There, the web 4 is divided into five similar partial webs by the cutting/grooving unit 14, i.e. the printed image 6 has five similar images next to one another in the transverse direction Q, which are to be separated from one another accordingly and a certain width is specified as the target measurement S in the order data 34. This ideal case is shown in FIG. 3, where the target measurement S matches the printed image 6. On its way to the cutting/grooving unit 14, however, the web 4 undergoes an unexpected dimensional change, e.g. the web 4 shrinks less than expected and now has an actual width B that is greater than a target width that results from the target measurement S (and, if applicable, an anticipated dimensional change, which, however, is not actually carried out). This is shown in FIG. 4 and results in parts of the image of one panel 26 lying on the neighboring panel 26 when it is divided. For example, when considering a single sheet 19 that has been formed into a finished folding box, the printed image 6 appears shifted relative to the edges and borders of the folding box, i.e. the print edge and the cut edge do not match. Since the web 4 is typically guided into the cutting/grooving unit 14 in a central position as shown in FIG. 3-5, the corresponding error increases outward in the transverse direction Q, as can be clearly seen in FIG. 4. The scaling of the processing positions 16 to the actual printed image 6 described here by accordingly setting the cutting/grooving unit 14 depending on the scaling factor F and starting from FIG. 4 is then shown in FIG. 5, where cuts and grooves again match the printed image 6 optimally.

In addition to the described adaptation of the processing positions 16 to the printed image 6, an anticipated dimensional change of the web 4 is also taken into account in the present case. Accordingly, with the method, a dimensional change in the web 4 is estimated (anticipated) in advance during its processing within the installation 2 and it is taken into account that the printed image 6 is printed on in a scaled, e.g. enlarged, manner, so that a variation in the estimated dimensional change is then compensated for by the already described adaptation of the processing positions 16 to the printed image 6. The estimated dimensional change is above all an expected dimensional change, which does not necessarily happen completely in the further course of the web 4 through the installation 2, so that despite taking this into account, the situation shown in FIG. 4 occurs at the cutting/grooving unit. This results from variations compared to the estimated dimensional change. The method described here thus advantageously contains two compensation mechanisms for any dimensional changes in the web 4, namely, on the one hand, for an estimated dimensional change and, on the other hand, for an actual dimensional change, specifically a variation (or deviation) from the estimated dimensional change. Firstly, the printed image 6 itself is scaled from the outset depending on the anticipated dimensional change, e.g. target measurements S of the printed image 6 are multiplied by a corresponding scaling factor (not the aforementioned scaling factor F). The anticipated dimensional change is regularly based on empirical values that depend on the specific job and the paper used and typically does not take into account any variations during operation, i.e. no dynamic dimensional change that results, e.g., from a varying web speed or from deviations when drying or moistening the web 4. Such a dimensional change is now specifically taken into account by the method described here, because the measurement of the actual measurement I detects precisely such a dimensional change and then automatically compensates for it dynamically and in real time by scaling the processing positions 16. As a whole, this implements a two-stage correction, in which a first, coarse, static correction is carried out in a first stage by adapting the printed image 6 to the anticipated dimensional change in advance, and then a second, fine, dynamic correction is carried out in a second stage by adapting the processing positions 16 to the printed image 6 as described in connection with FIG. 5.

The scaling factor F is formed from the actual measurement I and the target measurement S, e.g. simply as the ratio of the actual measurement I to the target measurement S or in another suitable manner. The target measurement S is taken from the order data 34 for processing the web 5 and is typically specified by the customer. The target measurement S is a measurement of the dimensions that the single panels 26 or sheets 18 should have at the end, e.g. simply the sum of the widths of the partial webs 26 if the actual measurement I is simply the width B of the entire web. The target measurement S also specifies the processing positions 16, which are now scaled in the method described here in order to be adapted to the actual printed image 6.

For an adaptation of the processing positions 16 to the printed image 6 that is as optimal as possible, the actual measurement I is measured as close as possible to the cutting/grooving unit 14, e.g. no more than 10 m or even no more than 1 m upstream of the cutting/grooving unit 14. In principle, various embodiments are possible and suitable for the actual measurement I; what is essential is that this allows conclusions to be drawn about the actual width B and thus about the dimensions of the actual printed image 6.

In a first possible embodiment, the actual measurement I is simply the actual width B of the web 4. The actual measurement I is measured, for example, with a web width or web edge recognition system, for which the installation 2 has a corresponding sensor unit 36. In a second possible embodiment, the actual measurement I is a distance between two printed features 38 of the printed image 6, e.g. as shown in FIG. 6. In this embodiment, the printed image 6 is accordingly analyzed directly in order to recognize any dimensional change in the web 4 and the printed image 6. Which printed features 38 are actually used is initially irrelevant. However, these are as far apart as possible along the width B of the web 4, i.e. the distance between the two printed features 38 in the transverse direction Q is as large as possible. In FIG. 6, the distance is at least 50% of the width B and the two printed features 38 are even located on different partial webs 26, specifically on the two outermost partial webs 26.

In principle, all features that are present in the printed image 6 are suitable as printed features 38, for example the aforementioned logos 8, decorations and control codes 12 and generally those printed features 38 that are already present and do not need to be printed on in addition, for example the control codes 12 for the subsequent cross cutter 28.

In the present case, the actual measurement I is determined by means of two sensors, which at the same time also set the cutting/grooving unit 14 as a whole relative to the web course in the cutting/grooving unit 14. The web course refers to the position of the web 4 relative to the transverse direction Q. The two sensors are part of the sensor unit 36 and are used to track the cutting/grooving unit 14 in order to adapt the processing positions 16 to the general web course overall and initially independently of a dimensional change. For this purpose, the web course is measured with the sensors and the cutting/grooving unit 14 is then positioned correctly in the transverse direction Q depending on this. In addition, the actual measurement I is now also measured with these two sensors. Accordingly, the sensors are designed for recognizing the specified printed features 38 or the width B.

For producing cuts and/or grooves at the processing positions 16, the cutting/grooving unit 14 has a plurality of processing bodies 42, for example as shown in FIG. 7. These processing bodies 42 are provided along the transverse direction Q and are designed for mechanical processing of the web 4 in order to introduce cuts and/or grooves therein by a mechanical action. A particular processing body 42 has, e.g., a pair of rollers comprising two rollers and in each case one cutting blade or a groove contour. The processing bodies 42 are adjustable relative to one another and the cutting/grooving unit 14 is set by adjusting the processing bodies 42 relative to one another. In other words, the processing positions 16 are scaled and adapted to the printed image 6 by adjusting the processing bodies 42 relative to one another accordingly, e.g. by suitably increasing or decreasing their distance in the transverse direction Q. In FIG. 7, the processing bodies 42 are designed for parallel positioning and can be adjusted separately from one another for this purpose. The cutting/grooving unit 14 has a separate adjustment mechanism 44 for each of the processing bodies 42 (e.g., in each case comprising a spindle) and the adjustment mechanisms 44 can be controlled independently of one another. This is in contrast to serial positioning, in which only a single adjustment mechanism is used for a plurality of processing bodies 42.

The installation 2 also has a control unit 46, which is designed to ascertain the scaling factor F from the actual measurement I together with the target measurement S, in order to then adapt the processing positions 16 to the actual width B as described. The control unit 46 is then further designed, as described, to set the cutting/grooving unit 14 depending on the scaling factor F such that the processing positions 16 are adapted to the printed image 6.

### LIST OF REFERENCE SIGNS

2 installation
4 web
6 printed image
8 logo
10 decoration
12 control code
14 cutting/grooving unit
16 processing position
18 sheet
20 double facer
22 wet end
24 dry end
26 panel (partial web)
28 cross cutter
30 divider
32 short cross cutter
34 order data
36 sensor unit
38 printed feature
42 processing body
44 adjustment mechanism
46 control unit
B actual width
F scaling factor
I actual measurement
L longitudinal direction
Q transverse direction
S target measurement

1. A method for processing a web which is printed with a printed image,
wherein the web is fed to a cutting/grooving unit by means of which the web is processed at a number of processing positions in the longitudinal direction (L),
wherein upstream of the cutting/grooving unit the web has a width (B),
wherein an actual measurement (I) for the width (B) is measured,
wherein the cutting/grooving unit is set depending on the actual measurement (I) and a target measurement (S) for the width (B) such that the processing positions are adapted to the printed image.

2. The method according to claim 1,
wherein a dimensional change in the web is estimated in advance during its processing and it is taken into account that the printed image is printed on in a scaled manner, so that a variation in the estimated dimensional change is compensated for by the adaptation of the processing positions to the printed image.

3. The method according to claim 1,
wherein a scaling of the printed image is controlled depending on the actual measurement (I) to the target measurement (S), so that the printed image is adapted to the target measurement (S).

4. The method according to claim 1,
wherein the actual measurement (I) is measured at most 10 m upstream of the cutting/grooving unit.

5. The method according to claim 1,
wherein the actual measurement (I) is a distance between two printed features of the printed image.

6. The method according to claim 1,
wherein the actual measurement (I) is the width (B).

7. The method according to claim 1,
wherein the actual measurement (I) is determined by means of two sensors, which at the same time also set the cutting/grooving unit as a whole relative to the web course in the cutting/grooving unit.

8. The method according to claim 1,
wherein the cutting/grooving unit for producing cuts and/or grooves has a plurality of processing bodies which are adjustable relative to one another,
wherein the cutting/grooving unit is set by adjusting the processing bodies relative to one another.

9. The method according to claim 8,
wherein the processing bodies are designed for parallel positioning and can be adjusted separately from one another for this purpose.

10. The method according to claim 1,
wherein the web is a corrugated cardboard web.

11. An installation for processing a web that is printed with a printed image,
comprising a cutting/grooving unit to which the web is fed in order to process it at a number of processing positions in the longitudinal direction (L),
wherein upstream of the cutting/grooving unit the web has a width (B),
comprising a sensor unit that is designed for measuring an actual dimension (I) of the width (B),
comprising a control unit that is designed to set the cutting/grooving unit depending on the actual measurement (I) and a target measurement (S) for the width (B) such that the processing positions are adapted to the printed image.
